(19) United States
(12) Patent Application Publication
(10) Pub. No.: US 2016/0170429 A1
(43) Pub. Date: Jun. 16, 2016

(54) SYSTEM AND METHOD FOR NON-LINEAR MODEL PREDICTIVE CONTROL OF MULTI-MACHINE POWER SYSTEMS

(71) Applicant: King Fahd University of Petroleum and Minerals, Dhahran (SA)

(72) Inventors: Mohammed Mansoor BIN THABIT, Sanaa (YE); Zakariya Mahmoud AL-HAMOUZ, Dhahran (SA)

(73) Assignee: King Fahd University of Petroleum and Minerals, Dhahran (SA)

(21) Appl. No.: 14/970,090

(22) Filed: Dec. 15, 2015

Related U.S. Application Data
(60) Provisional application No. 62/092,034, filed on Dec. 15, 2014.

(51) Int. Cl. G05F 1/66; G05B 13/04

(52) U.S. Cl. CPC G05F 1/66; G05B 13/048

(57) ABSTRACT

A controller includes circuitry configured to detect an occurrence of a transient instability event at a multi-machine power system (MMPS) based on one or more sensed operational parameters at one or more energy generation devices. Excitation voltage input values to the one or more energy generation devices are determined over a predetermined prediction horizon based on minimizing a predetermined cost function bound by one or more constraints. Control signals are output to one or more actuators associated with the energy generation devices based on the excitation voltage input values to reduce a length of time of the transient instability event.

### CROSS-REFERENCE TO RELATED APPLICATIONS

The present application claims the benefit of the earlier filing date of U.S. provisional application 62/092,034 having common inventorship with the present application and filed in the U.S. Patent and Trademark Office on Dec. 15, 2014, the entire contents of which being incorporated herein by reference.

### BACKGROUND

1. Technical Field

The present disclosure is directed to model predictive control (MPC) of multi-machine power systems (MMPS).

2. Description of the Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

In large-scale power networks, the presence of disturbances may degrade the stability of the systems so providing methods of bringing the power systems to equilibrium in the presence of the disturbances becomes important. Conventional controllers which are used to improve the transient stability of a Multi-Machine Power System (MMPS) are usually based on a linearization of the dynamic model of the system. This method is impractical for large scale power systems, as described in H. Ye and Y. Liu, “Wide-area model predictive damping controller based on online recursive closed-loop subspace identification,” in International Conference on Power System Technology. Technological Innovations Making Power Grid Smart, 2010, the entire contents of which are incorporated herein by reference. Handling the physical constraints of power systems with the conventional controllers can be a large challenge.

Some controllers use Model Predictive Control (MPC) during power transients for process control and other types of power systems control because MPC controllers can include a greater variety of features compared to other conventional control approaches. The MPC controllers have capability of handling multiple manipulated and controlled variables and allowing constraints to be imposed on both the manipulated and controlled variables.

Linear MPC (LMPC) is provides stabilization of MMPS based on a linearized model. For example, Generalized Predictive Control (GPC), a form of predictive control, is used for emergency control of transient stability based on the Extended Equal Area Criterion (EEAC), as described by L. Yi-qun, Tenglin, L. Wang-shun, and L. Jian-fei, “The study on real-time transient stability emergency control in power system,” in Canadian Conference on Electrical and Computer Engineering, vol. 1, pp. 138-143, 2002, the entire contents of which are incorporated herein by reference. Hybrid shuffled frog leaping can be used as an optimizer to minimize the cost function of the GPC model in order to damp the low-frequency oscillations, as described in E. Bijami, J. Askari, and M. Farsangi, “Design of stabilising signals for power system damping using generalised predictive control optimised by a new hybrid shuffled frog leaping algorithm,” IET Generation, Transmission & Distribution, vol. 6, no. 10, pp. 1036-1045, 2012, the entire contents of which are incorporated herein by reference.

Both Linear and Nonlinear Model Predictive Control (NMPC) for Multi-Machine Power Systems provide improvement in handling the disturbances and satisfying the constraints associated with stability disturbances in power systems. The MPC approach involving the identification of a MMPS model is introduced to enhance the stability of MMPS. In B. Wu and O. P. Malik, “Multivariable adaptive control of synchronous machines in a multimachine power system,” IEEE Transactions on Power Systems, vol. 21, no. 4, pp. 1772-1781, 2006, the entire contents of which have been incorporated by reference, a multivariable adaptive power system stabilizer based on a recursive subspace identification method and GPC strategy is proposed. The time varying model of MMPS is identified by the robust control followed by H_∞ control design and different cases for the use of MPC with and without Power System Stabilizer (PSS) are studied in A. Soos and O. P. Malik, “Robust multi-model based control,” in Power India Conference, 2006, the entire contents of which have been incorporated herein by reference.

An adaptive damping method is proposed by integrating online recursive closed-loop subspace model identification with model predictive control theory in H. Ye and Y. Liu, “Wide-area model predictive damping controller based on online recursive closed-loop subspace identification,” in International Conference on Power System Technology: Technological Innovations Making Power Grid Smart, 2010. It is different from E. Bijami, J. Askari, and M. Farsangi, “Design of stabilising signals for power system damping using generalised predictive control optimised by a new hybrid shuffled frog leaping algorithm,” IET Generation, Transmission & Distribution, vol. 6, no. 10, pp. 1036-1045, 2012, in two ways in that an online recursive closed-loop subspace identification method is developed and a focus is placed on damping inter-area oscillation modes.

In addition, MPC with Flexible AC Transmission System (FACTS) devices can be used to improve MMPS stability. In D. Wang, M. Glavic, and L. Wehenkel, “A new MPC scheme for damping wide-area electromechanical oscillations in power systems,” in PowerTech, 2011, the entire contents of which are incorporated herein by reference, an MPC approach with Thyristor Controlled Series Compensators (TCSCs) and Static Var Compensators (SVCs) are introduced to damp wide-area electromechanical oscillations. An emergency control based on a MPC scheme using TCSC is proposed to improve the transient stability in X. Du, D. Ernst, and P. Crossley, “A model predictive based emergency control scheme using tcsc to improve power system transient stability,” in Power and Energy Society General Meeting, pp. 1-7, 2012, the entire contents of which are incorporated herein by reference. A distributed MPC demonstrated to damp wide-area electromechanical oscillations in large-scale electric power systems is described in D. Wang, M. Glavic, and L. Wehenkel, “Distributed mpc of wide-area electromechanical oscillations of large-scale power systems,” in International Conference on Intelligent System Application to Power Systems (ISAP), pp. 1-7, 2011, the entire contents of which are incorporated herein by reference. In M. Moradzadeh, L. Bhojwani, and R. Boel, “Coordinated voltage control via distributed model predictive control,” in Chinese Control and Decision Conference (CCDC), pp. 1612-1618, 2011, the entire contents of which is incorporated herein by reference, and M. Moradzadeh, R. Boel, and L. Vandevelde, “Voltage coordination in multi-area power systems via distributed model predictive control,” IEEE Transactions on Power Systems, vol. 28, no. 1, pp. 513-521, 2013, the entire contents of which is incorporated herein by reference, voltage control based on distributed MPC is developed. The MPC approach is used in order to robustly tune the PSS and Automatic Voltage Regulator (AVR), as described in Y. Qudaih, Y. Mitani, and T. Mohamed, “Wide-area power system oscillation damping using robust control technique,” in Asia-Pacific Power and Energy Engineering Conference (APPEEC), pp. 1-4, 2012, the entire contents of which have been incorporated herein by reference.

The NMPC is addressed to solve MMPS power stability issues. A framework is presented for the development of discrete nonlinear predictive control using coordination control of TCSC to stabilize and provide rapid damping of the MMPS subjected to large disturbances as described in V. Rajkumar and R. R. Mohler, “Nonlinear predictive control for the damping of multi-machine power system transients using FACTS devices,” in Proceedings of the IEEE Conference on Decision and Control, vol. 4, pp. 4074-4079, 1994, the entire contents of which have been incorporated herein by reference. Using this strategy for large faults, the NMPC with a small prediction horizon is designed to return the power system state to a small region approaching the post-fault equilibrium. In this region, the linear controller can be designed to provide local asymptotic stabilization. In M. Zima and G. Andersson, “Model predictive control employing trajectory sensitivities for power systems applications,” in Proceedings of the 44th IEEE Conference on Decision and Control, and the European Control Conference, pp. 4452-4456, 2005, the entire contents of which are incorporated herein by reference, a formulation of the MPC is developed to control the reactive power and voltages of MMPS based on trajectory sensitivities. Emergency voltage control of the power system based on a tree search and NMPC approaches are presented in M. Larsson, D. J. Hill, and G. Olsson, “Emergency voltage control using search and predictive control,” International Journal of Electrical Power and Energy Systems, vol. 24, no. 2, pp. 121-130, 2002, the entire contents of which are incorporated herein by reference. The NMPC control with short horizon is introduced by choosing an appropriate terminal cost function to achieve the first swing transient stability of MMPS using FACTS devices as described in J. J. Ford, G. Ledwich, and Z. Y. Dong, “Efficient and robust model predictive control for first swing transient stability of power systems using flexible ac transmission systems devices,” IET Generation, Transmission and Distribution, vol. 2, no. 5, pp. 731-742, 2008, the entire contents of which are incorporated herein by reference.

### SUMMARY

In an exemplary embodiment, a controller includes circuitry configured to detect an occurrence of a transient instability event at a multi-machine power system (MMPS) based on one or more sensed operational parameters at one or more energy generation devices. Excitation voltage input values to the one or more energy generation devices are determined over a predetermined prediction horizon based on minimizing a predetermined cost function bound by one or more constraints. Control signals are output to one or more actuators associated with the energy generation devices based on the excitation voltage input values to reduce a length of time of the transient instability event.

In another exemplary embodiment, a method includes detecting, via a controller having circuitry, an occurrence of a transient instability event at a multi-machine power system (MMPS) based on one or more sensed operational parameters at one or more energy generation devices; determining, via the circuitry, excitation voltage input values to the one or more energy generation devices over a predetermined prediction horizon based on minimizing a predetermined cost function bound by one or more constraints; and outputting, via the circuitry, control signals to one or more actuators associated with the energy generation devices based on the excitation voltage input values to reduce a length of time of the transient instability event.

In another exemplary embodiment, a non-transitory computer readable medium having instructions stored therein that, when executed by one or more processor, cause the one or more processors to perform a method of controlling a response to transient instability events, the method including: detecting an occurrence of a transient instability event at a multi-machine power system (MMPS) based on one or more sensed operational parameters at one or more energy generation devices; determining excitation voltage input values to the one or more energy generation devices over a predetermined prediction horizon based on minimizing a predetermined cost function bound by one or more constraints; and outputting control signals to one or more actuators associated with the energy generation devices based on the excitation voltage input values to reduce a length of time of the transient instability event.

The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 is an exemplary illustration of a diagram of a multi-machine power system (MMPS) control system, according to certain embodiments;

FIG. 2 is an exemplary illustration of a MMPS, according to certain embodiments;

FIG. 3 is an exemplary flowchart of a non-linear model predictive control (NMPC) process, according to certain embodiments;

FIG. 4 is an exemplary flowchart of a MMPS control process, according to certain embodiments;

FIG. 5 is an exemplary table of load flow results for a MMPS, according to certain embodiments;

FIG. 6A is an exemplary graph of angle deviations between machines of a MMPS, according to certain embodiments;

FIG. 6B is an exemplary graph of angle deviations between machines of a MMPS, according to certain embodiments;

FIG. 7A is an exemplary graph of speed deviations between machines of a MMPS, according to certain embodiments;

FIG. 7B is an exemplary graph of speed deviations between machines of a MMPS, according to certain embodiments;

FIG. 8 is an exemplary graph of internal voltage of a machine, according to certain embodiments;

FIG. 9 is an exemplary graph of control efforts by a NMPC controller, according to certain embodiments;

FIG. 10 is an exemplary graph of speed deviations between machines during changes in load, according to certain embodiments;

FIG. 11A is an exemplary graph of speed deviation between machines of a MMPS, according to certain embodiments;

FIG. 11B is an exemplary graph of speed deviations between machines of a MMPS, according to certain embodiments;

FIG. 12 is an illustration of a non-limiting example of base station circuitry, according to certain embodiments;

FIG. 13 is an exemplary schematic diagram of a data processing system, according to certain embodiments; and

FIG. 14 is an exemplary schematic diagram of a processor, according to certain embodiments.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise. The drawings are generally drawn to scale unless specified otherwise or illustrating schematic structures or flowcharts.

Furthermore, the terms “approximately,” “approximate,” “about,” and similar terms generally refer to ranges that include the identified value within a margin of 20%, 10%, or preferably 5%, and any values therebetween.

Aspects of the present disclosure are directed to non-linear model predictive control (NMPC) of multi-machine power systems (MMPS) to provide stability during power disturbances and/or transients. The examples described in M. Zima and G. Andersson, “Model predictive control employing trajectory sensitivities for power systems applications,” in Proceedings of the 44th IEEE Conference on Decision and Control, and the European Control Conference, pp. 4452-4456, 2005 and M. Larsson, D. J. Hill, and G. Olsson, “Emergency voltage control using search and predictive control,” International Journal of Electrical Power and Energy Systems, vol. 24, no. 2, pp. 121-130 are concerned with the use of NMPC to improve the voltage stability. On the other hand, Rajkumar and R. R. Mohler, “Nonlinear predictive control for the damping of multimachine power system transients using facts devices,” in Proceedings of the IEEE Conference on Decision and Control, vol. 4, pp. 4074-4079, 1994 and J. J. Ford, G. Ledwich, and Z. Y. Dong, “Efficient and robust model predictive control for first swing transient stability of power systems using flexible ac transmission systems devices,” IET Generation, Transmission and Distribution, vol. 2, no. 5, pp. 731-742, 2008, introduced the NMPC to improve the transient stability using FACTS devices. In addition, each machine is represented by only a second order model. Furthermore, the previous methods do not take into consideration the physical constraints imposed on the excitation voltage. As such, aspects of the present disclosure introduce implementations of the NMPC to improve the transient stability of MMPS when subjected to large disturbances including three-phase faults and substantial changes in load. In addition, each machine of the MMPS can represented by a third order model without FACTS devices and uses an excitation voltage input with constraints to maintain operational stability of the MMPS.

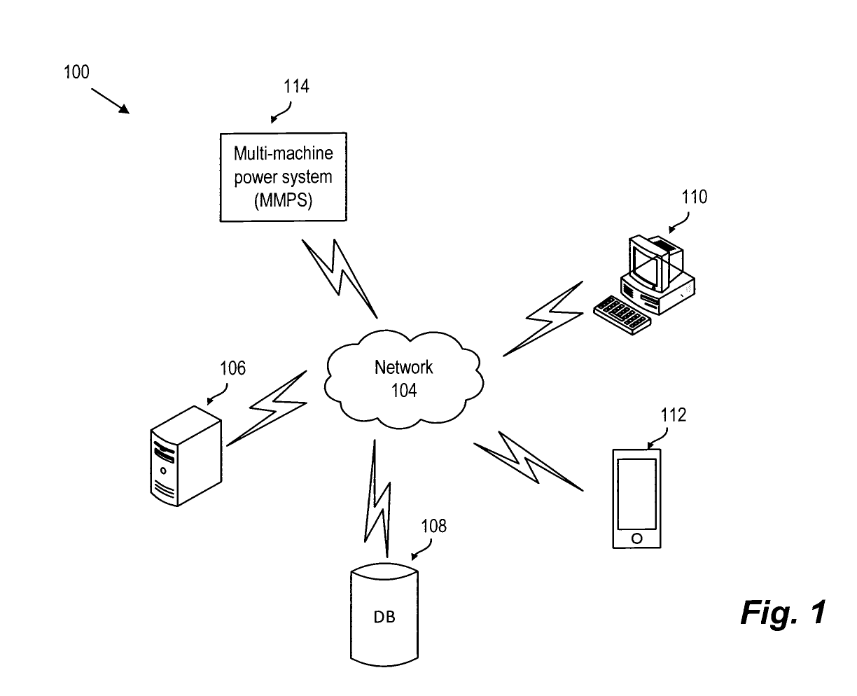

FIG. 1 is a schematic diagram of a MMPS control system 100, according to certain embodiments. The computer 110 represents at least one computer 110 and acts as a client device that is connected to a database 108, a mobile device 112, a server 106, and a multi-machine power system (MMPS) 114 via a network 104. In some implementations, an interface at the computer 110 is used to monitor and/or modify operational parameters of the machines of the MMPS 114, which can include one or more generators or other energy-producing devices. For example, an operator of the MMPS 114 can monitor sensor values of the machines, such as internal voltages, bus voltages, excitation voltage, currents, rotor angle, rotor speed, and the like. The operator of the MMPS 114 can also use the computer 110 to modify one or more parameters associated with the non-linear model predictive control (NMPC) of the MMPS 114. For example, the operator can input and/or modify constraints on an excitation voltage input, state variables, and/or cost function used to stabilize the MMPS during instabilities such as power disturbances or load changes. Details regarding the MMPS 114 and NMPC are discussed further herein.

The server 106 represents one or more servers connected to the computer 110, the database 108, the MMPS 114, and the mobile device 112 via the network 104. According to certain embodiments, the server 106 acts as a controller that implements one or more processes associated with applying NMPC to the MMPS 114. As such, throughout the disclosure, the server 106 can be interchangeably referred to as the controller 106. Details regarding the processes performed by the controller 106 are discussed further herein. In some implementations, processing circuitry of the server 106 receives sensor data from the machines of the MMPS 114, detects occurrences of transient instability events such as power disturbances or load changes at the machines based on the sensor values, which can be detected based on deviations in the operational parameters monitored by the sensors of the MMPS 114 such as voltages, currents, and the like. The controller 106 performs a cost function optimization based on one or more constrains to determine excitation voltage input values to the machines over a predetermined prediction horizon, and outputs control signals to the machines of the MMPS based on the results of the cost function computation. For example, the controller 106 can output control signals to an excitation controller of the machines of the MMPS 114 to modify the excitation voltage of the machines. Note that each of the functions of the described embodiments may be implemented by one or more processing circuits that include circuitry, which can also be interchangeably referred to as processing circuitry throughout the disclosure.

The database 108 represents one or more databases connected to the computer 110, the server 106, the MMPS 114, and the mobile device 112 via the network 104. In some implementations, historical data associated with the MMPS control system 100, such as tables, logs, and graphs of the sensor values associated with the machines of the MMPS 114 over a predetermined period of time can be stored in the database 108. In addition, the historical data stored in the database 108 can also include instability data, such as times associated with transient instability events, such as power disturbances and/or load changes as well as sensor values that measure operational parameters of the machines of the MMPS 114 when transient instability events occur. In some implementations, the processing circuitry of the controller 106 can use the instability data to update the constraints of the cost function as well as model functions of the machines.

The MMPS 114 represents one or more MMPSs connected to the computer 110, the controller 106, the database, 108, and the mobile device 112 via the network 104. In some implementations, the MMPS 114 can include one or more energy generation devices such as generators connected to electrical busses that supply power to one or more loads. The energy generation devices can interchangeably be referred to as machines throughout the disclosure. For example, the MMPS 114 may be a Western System Coordinating Council (WSCC) 3-phase, 9-bus power system that receives power from three generators. The generators can be synchronous generators, induction generators, or any other type of generator. The generators can include turbines that are driven by one or more sources, such as wind, water, steam, or gas. In addition, the machines of the MMPS 114 can have sensors installed that can be configured to sense such as internal voltages, bus voltages, excitation voltage, currents, rotor angle, rotor speed, temperature, pressure, and other types of operational parameters associated with the machines. The sensors associated with each of the machines can transmit sensor data via the network 104 to the controller 106 for further processing. In some implementations, the sensor data from each machine of the MMPS 114 is used by the controller 106 to predict a response by the machines to transient instability events in order to reduce an amount of time it takes for the MMPS 114 to return to a stable equilibrium state after the power disturbance or change in load. Details regarding the MMPS 114 are discussed further herein.

The mobile device 112 represents one or more mobile devices connected to the computer 110, the server 106, the MMPS 114, and the database 108 via the network 104. The network 104 represents one or more networks, such as the Internet, connecting the computer 110, the server 106, the database 108, the MMPS 114, and the mobile device 112. The network 104 can also communicate via wireless networks such as WI-FI, BLUETOOTH, cellular networks including EDGE, 3G and 4G wireless cellular systems, or any other wireless form of communication that is known.

As would be understood by one of ordinary skill in the art, based on the teachings herein, the mobile device 112 or any other external device could also be used in the same manner as the computer 110 to input, view, and or modify one or more operational parameters associated with the MMPS control system 100. In addition, the computer 110 and mobile device 112 can be referred to interchangeably throughout the disclosure. Details regarding the processes performed by the MMPS control system 100 are discussed further herein.

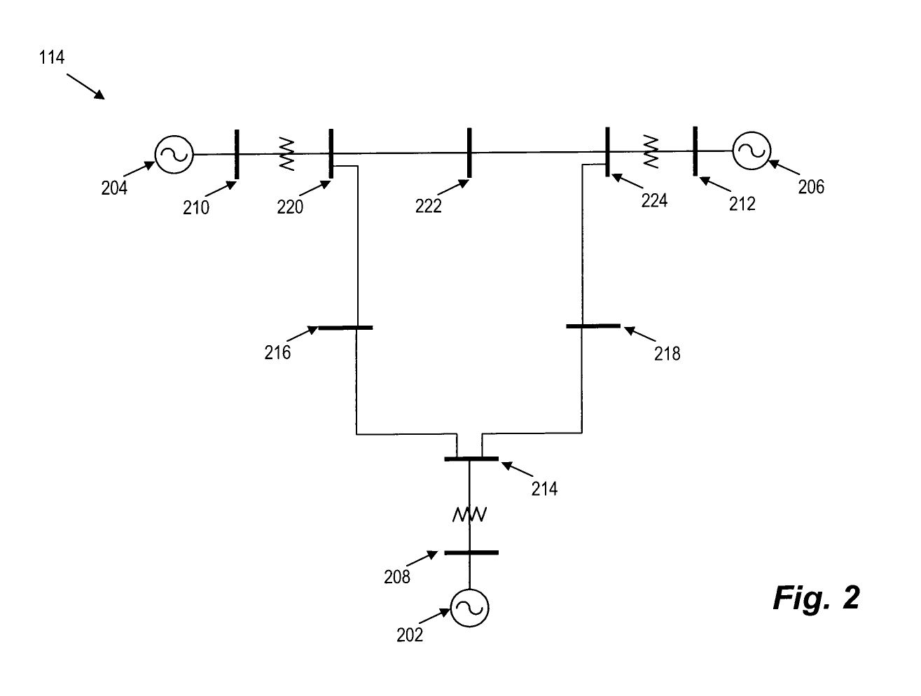

FIG. 2 is an exemplary illustration of a MMPS 114, according to certain embodiments. In one implementation, the MMPS 114 can include one or more energy generation devices such as generators connected to electrical busses that supply power to one or more loads. For example, the MMPS 114 may be a Western System Coordinating Council (WSCC) 3-phase, 9-bus power system that receives power from three generators 202, 204, and 206 as described in N. Yadaiah and N. V. Ramana, “Linearisation of multi-machine power system: Modeling and control—a survey,” International Journal of Electrical Power and Energy Systems, vol. 29, no. 4, pp. 297-311, 2007, the entire contents of which is incorporated herein by reference. Other types of electrical systems and configurations can also be used. The generators 202, 204, and 206 can be synchronous generators, induction generators, or any other type of generator. In addition, the generators 202, 204, and 206 can include turbines that are driven by one or more sources, such as wind, water, steam, or gas. For example, the generator 202 may be a hydro generator, and the generators 204 and 206 may be steam generators. In addition, generators 202, 204, and 206 can interchangeably be referred to as machines throughout the disclosure. The generators 202, 204, and 206 provide electrical power to nine electrical busses 208, 210, 212, 214, 216, 218, 220, 222, and 224, which in turn provide electrical power to various electrical loads that are connected to the MMPS 114.

In addition, the machines of the MMPS 114 can have sensors installed that can be configured to sense such as internal voltages, bus voltages, excitation voltage, currents, rotor angle, rotor speed, temperature, pressure, and other types of operational parameters associated with the machines. The sensors associated with each of the machines can transmit sensor data via the network 104 to the controller 106 for further processing. For example, the sensor data can be used to determine other values associated with the generators 202, 204, and 206, such as reactive power, inertia constant, damping power coefficient, synchronous reactance, transient reactance, and the like. In some implementations, the sensor data from each machine of the MMPS 114 is used by the controller 106 to predict a response by the machines to transient instability events in order to reduce an amount of time it takes for the MMPS 114 to return to a stable equilibrium state after the power disturbance or change in load.

According to certain embodiments, dynamics of operating the MMPS 114 can be highly non-linear and can be represented by a third order model of each i-th machine as described in N. Yadaiah and N. V. Ramana, “Linearisation of multi-machine power system: Modeling and control—a survey,” International Journal of Electrical Power and Energy Systems, vol. 29, no. 4, pp. 297-311, 2007; F. A. Anderson PM, Power system control and stability, New Jersey: IEEE press, 1994; and K. Padiyar, Power system dynamics, BS publications, 2008, the entire contents of which are incorporated herein by reference. For example, each of the generators 202, 204, and 206 can be represented by the following equations:

$$\begin{matrix}{\dot{δ}}_{i} = {ω}_{i} - {ω}_{0} & ( 1 ) \\ {\dot{ω}}_{i} = \frac{{ω}_{0}}{2 H} [ {P}_{mi} - \frac{{D}_{i}}{{ω}_{0}} [ {ω}_{i} - {ω}_{0} ] - {P}_{ei} ] & ( 2 ) \\ {\dot{E}}_{qi}^{′} = \frac{1}{{T}_{doi}^{′}} [ {u}_{i} - {E}_{qi} ] & ( 3 ) \\ Where & \\ {E}_{qi} = {E}_{qi}^{′} + ( {x}_{d} - {x}_{d}^{′} ) {I}_{di} & ( 4 ) \\ {P}_{ei} = {\sum }_{j = 1}^{n} {E}_{qi}^{′} [ {G}_{ij} cos {δ}_{ij} + {B}_{ij} sin {δ}_{ij} ] {E}_{qj}^{′} & ( 5 ) \\ {P}_{ei} = {\sum }_{j = 1}^{n} {E}_{qi}^{′} [ {G}_{ij} cos {δ}_{ij} + {B}_{ij} sin {δ}_{ij} ] {E}_{qj}^{′} & ( 6 ) \\ {I}_{di} = - \frac{{Q}_{ei}}{{E}_{qi}^{′}} & ( 7 )\end{matrix}$$

The terms used in equations (1) through (7) to describe the dynamics of the MMPS 114 can be defined as follows. Also, values for the terms used in equations (1) through (7) can be determined from the sensor data received from the sensors associated with the generators 202, 204, 206, or can be calculated based on the sensor data values. For example, rotor speed, currents, voltages, and the like, can be directly determined from the sensor data, but terms such as reactive power, inertia constant, damping power coefficient, synchronous reactance, and transient reactance can be calculated by the processing circuitry of the controller 106. In addition, for a given quantity, such as voltage, current, power, impedance, and the like, a per unit (p.u.) value is the value related to a quantity expressed in SI units base value:

δᵢ: Rotor angle of ith machine in radian.

ωᵢ: Rotor speed of ith machine in radian/s. ω₀: System reference speed in (2πf) radian/s, f=60 Hz.

I_{d}: Stator currents in d-axis of ith machine in p.u.

Pₘᵢ: Input mechanical power of ith machine in p.u.

Pₑᵢ, Qₑᵢ: Active and reactive power delivered at the terminals of ith machine in p.u.

E_{qi}′: Internal transient voltage in q-axis of ith machine in p.u.

Hᵢ: Inertia constant of ith machine in seconds.

Dᵢ: Damping power coefficient of ith machine in p.u.

x_{di}, x_{di}′: Synchronous reactance and transient reactance in d-axis of ith machine in p.u.

T_{doi}′: Field winding time constant in seconds.

Gᵢⱼ, Bᵢⱼ: Transfer conductance and susceptance between buses i and j respectively in p.u, where the transfer admittance Yᵢⱼ=Gᵢⱼ+jBᵢⱼ.

uᵢ: Excitation voltage of ith machine in p.u.

For the ith machine, there are (3i) differential equations. Thus, the MMPS 114 can have nine differential equations. For example, the set of non-linear third order differential equations (1), (2), and (3) can be written in the form:

\dot{x}=f(x,u) (8)

where x is the state vector of dimensions (3i×1) represented by

x=[δᵢ,ωᵢ,E_{qi}′] (9)

The excitation voltage (uᵢ) of ith machine, which is taken as an input of the MMPS 114 can have a physical limit such as a constraint represented by:

−uₘᵢₙ≦uᵢ≦uₘₐₓ (10)

In addition, Table I provides exemplary operational parameters for the generators 202, 204, and 206, and Table II provides exemplary system data for the bus connections of the MMPS 114.

TABLE I
MACHINE DATA

| Parameter | 202 | 204 | 206 |
|---|---|---|---|
| Rated MVA | 247.5 | 192.0 | 128.0 |
| KV | 16.5 | 18.0 | 13.8 |
| Power factor | 1.0 | 0.85 | 0.85 |
| Type | Hydro | Steam | Steam |
| Speed | 180 | 3600 | 3600 |
| (rad/min) | | | |
| x_{d} | 0.146 | 0.8958 | 1.3125 |
| x_{d}′ | 0.0608 | 0.1198 | 0.1813 |
| x_{q} | 0.0969 | 0.8645 | 1.2578 |
| x_{q}′ | 0.0969 | 0.1969 | 0.25 |
| x_{d0}′ | 8.96 | 6.0 | 5.89 |
| Stored energy | 2364 | 640 | 301 |
| at rated speed | | | |
| (MWs) | | | |

TABLE II
SYSTEM DATA

Impedance

| Bus no. | R | X | ½B |
|---|---|---|---|
| 208-214 | 0 | 0.0576 | 0 |
| 210-220 | 0 | 0.0625 | 0 |
| 212-224 | 0 | 0.0586 | 0 |
| 214-216 | 0.01 | 0.085 | 0.088 |
| 214-218 | 0.017 | 0.092 | 0.079 |
| 216-220 | 0.032 | 0.161 | 0.153 |
| 218-224 | 0.039 | 0.17 | 0.179 |
| 220-222 | 0.0085 | 0.072 | 0.0745 |
| 222-224 | 0.0119 | 0.1008 | 0.1045 |

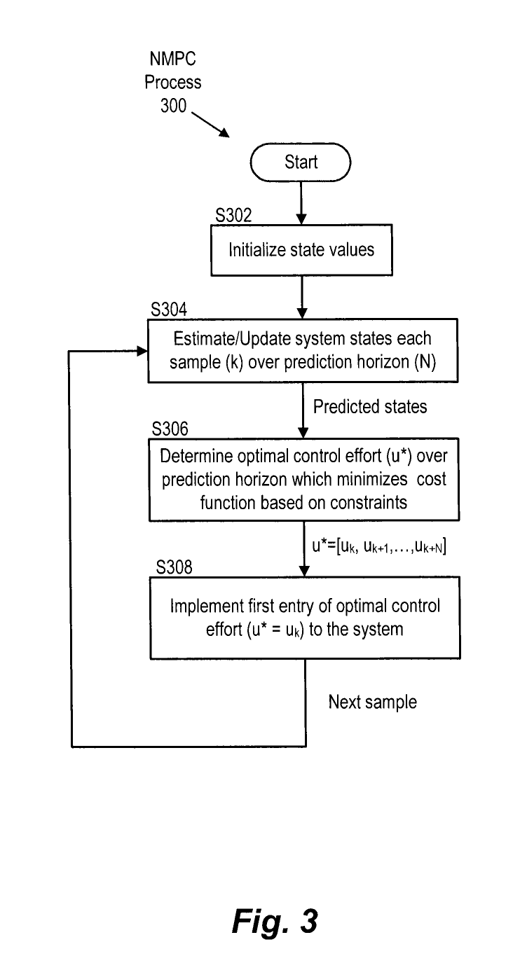

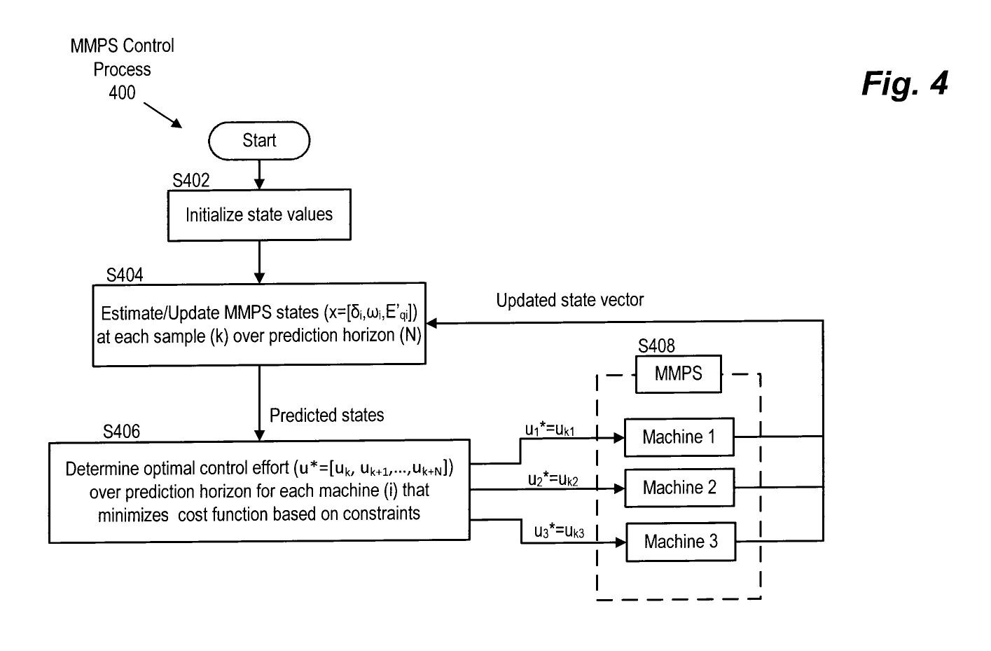

FIG. 3 is an exemplary flowchart of a non-linear model predictive control (NMPC) process 300, according to certain embodiments. In some implementations, model predictive control (MPC) can be defined as solving a finite on line horizon open loop optimal control problem subject to system dynamics and constraints imposed on states and controls as described by L. Grüne and J. Pannek, Nonlinear Model Predictive Control Theory and Algorithms. Springer, 2011; and R. Findeisen and F. Allgöwer, “An introduction to nonlinear model predictive,” in 21st Benelux Meeting on Systems and Control, Veidhoven, pp. 1-23, 2002, the entire contents of which are incorporated herein by reference. The steps of the NMPC process 300 are meant to provide a general summary of how NMPC can be used in various applications of control systems and is described with respect to a general control system. For example, the steps of the NMPC process 300 can be performed by the processing circuitry of the controller 106 with respect to the MMPS 114 but can also be applied to any control system that can be represented by a non-linear model. A detailed implementation of applying the NMPC process to the MMPS 114 is described further herein with respect to FIG. 4.

In some implementations, a non-linear control system can be described by:

x(k+1)=f(x(k),u(k)),x(0), x(0)=x₀ (11)

Subject to inputs and states:

u(k)εU (12)

x(k)εX (13)

Where U and X are input and state vectors, respectively.

At step S302, state values for the state vectors x(k) are initialized. The state values can be determined based on predictions of how the control system operates based on previously observed behaviors. For example, initial state values for the MMPS 114 can be determined based on load flow data for the generators and busses of the MMPS 114.

At step S304, the states for the control system, such as the MMPS system 100 are estimated and/or updated for each instant (k) for the prediction horizon (N). In one implementation, for a first iteration of the MMPS control process 400 are estimated based on the initialized state values determined at step S402. For subsequent iterations of the NMPC process 300, the state vectors are updated based on a current state of the control system determined at step S308 during the previous iteration of the process 300.

At step S306, the processing circuitry of the controller 106 determines an optimal control effort (u*) by minimizing a desired cost function over the prediction horizon (N) using the initial state values determined at step S302. The cost function to be minimized can be described by the following equation:

$$\begin{matrix}{J}_{N} = {\sum }_{k = 0}^{N - 1} F ( x ( k ) , u ( k ) ) & ( 14 ) \\ Where & \\ F ( x ( k ) , u ( k ) ) = {( \hat{x} ( k ) - {x}_{s} ( k ) )}^{T} Q ( \hat{x} ( k ) - {x}_{s} ( k ) ) + {u ( k )}^{T} Ru ( k ) & ( 15 )\end{matrix}$$

The terms used in equation (15) can be described as follows:
N: Prediction horizon.
\hat{x}(k): Predicted states.
xₛ(k): State set points.
Q and R: Denote positive, definite, symmetric weighting matrices.

In addition, the control system, such as the MMPS system 100, can be subjected to one or more constraints imposed on the inputs and the states, respectively, and can be described by the following:

−uₘᵢₙ≦uₖ≦uₘₐₓ (16)

−xₘᵢₙ≦xₖ≦xₘₐₓ (17)

The result of the cost function minimization at step S306 can be described by one or control effort values, u*=[uₖ, uₖ₊₁, . . . , u_{k+N}].

At step S308, a first entry of the control effort (u*=uₖ) is applied to the control system. For example, for the MMPS system 100, the control effort corresponds to an excitation voltage for each of the generators 202, 204, and 206. The controller 106 outputs a control signal to one or more actuators associated with an excitation controller of the generators 202, 204, and 206 to apply the control effort values to achieve a predetermined system response. The control effort value is then updated at step S304, and a subsequent sample (k) is processed.

FIG. 4 is an exemplary flowchart of a MMPS control process 400 based on NMPC, according to certain embodiments. The objective of the MMPS control process 400 performed by the controller 106 is to improve and/or maintain stability of MMPS 114 using a non-linear predictive control model after being subjected to transient instability events that result in large power disturbances, such as three-phase faults and load changes. In addition, the MMPS control process 400 improves the stability of the MMPS without the use of FACTs devices to assist with stabilizing the MMPS 114. The MMPS control process 400 is described with respect to the MMPS 114, but other types of electrical systems and configurations can also be used. Also, the MMPS control process 400 can provide stability control to the MMPS 114 during both transient instability events and steady-state operations.

In some implementations, the NMPC model used by the controller 106 is based on one or more assumptions in order to simplify the transient stability analysis of MMPS 114 as described in F. A. Anderson PM, Power system control and stability, New Jersey: IEEE press, 1994; K. Padiyar, Power system dynamics, BS publications, 2008; and P. M. Sauer PW, Power system dynamics and stability, India: Pearson Education, 2002, the entire contents of which are incorporated herein by reference. For example, the assumptions can include that each machine is represented by a constant voltage behind a direct axis transient reactance, no loss of power in transmission lines of the MMPS 114, governor actions at the generators 202, 204, and 206 are neglected and mechanical power may be assumed to be constant during a transient state, system data are converted to a common base, and loads are converted to equivalent admittances and generator armature resistances are neglected.

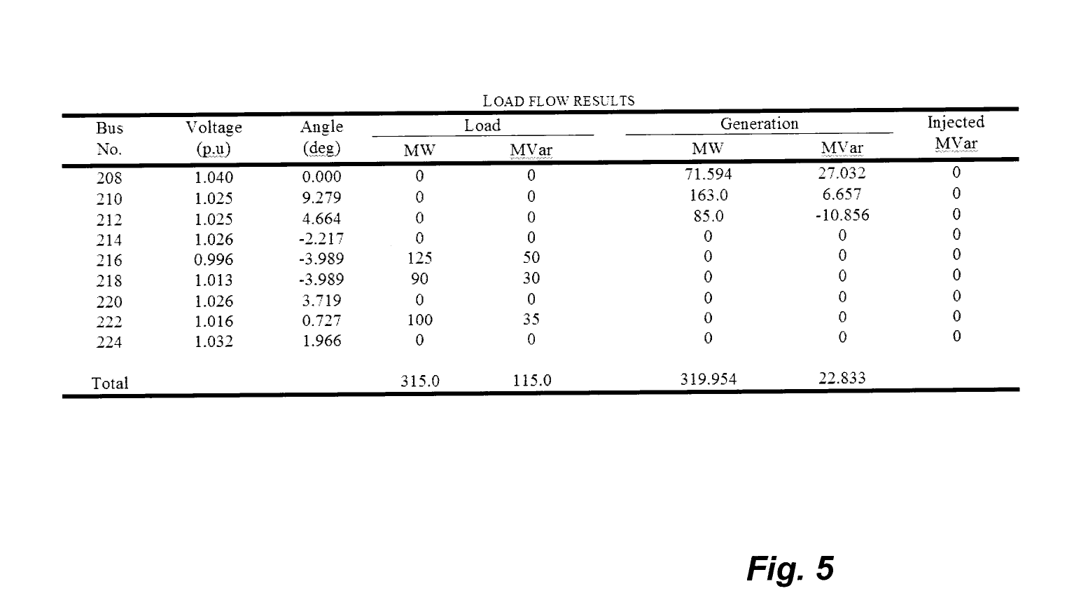

At step S402, state values for the state vectors x(k) are initialized. In some implementations, the state vector for each of the generators 202, 204, and 206 can be represented by equation (9). The values for each entry of the state vectors can be determined based on predictions of how the control system operates based on previously observed behaviors. For example, initial state values for the MMPS 114 can be determined based on load flow data for the generators and busses of the MMPS 114. In addition, operating conditions of the MMPS 114 can be determined from the load flow data via a fast-decoupled load flow technique. The load flow data for the MMPS 114 may also be stored in the database 108 and can be accessed by the controller 106 via the network 104. FIG. 5 is an exemplary table of load flow results for the MMPS 114, according to certain embodiments. For example, for each bus of the MMPS 114, the load flow results indicate a voltage and rotor angle along with associated real and reactive power values generated and consumed by one or more loads.

Referring back to FIG. 4, at step S404, the processing circuitry of the controller 106 estimates and/or updates the states of the third order model (x=[δᵢ, ωi, E_{q1}′]) for each instant (k) for the prediction horizon (N). In some implementations, the processing circuitry of the controller 106 determines the prediction horizon (N) based on one or more criteria. For example, the processing circuitry can modify the prediction horizon (N) based on a processing capacity of the controller 106. As the processing capacity of the controller 106 increases, the prediction horizon (N) can be increased, and as the processing capacity decreases, the prediction horizon (N) can be decreased.

In addition, the processing circuitry of the controller 106 can also determine the prediction horizon (N) based on a system stability measurement indicating how close the MMPS 114 is to a state of equilibrium. For example, the processing circuitry can determine the system stability measurement based on one or more sensed operational parameters at the generators 202, 204, and 206. The system stability measurement can indicate an amount of deviation in the sensor data received from the generators 202, 204, and 206 such that a larger system stability measurement indicates that the MMPS 114 is experiencing a greater amount of deviation in the sensor data and is therefore less stable. A smaller system stability measurement may indicate that the MMPS 114 is closer to equilibrium and may be more stable. In one implementation, as the MMPS 114 becomes more stable, the prediction horizon (N) may be increased, and as the MMPS 114 becomes less stable, the prediction horizon (N) may be decreased.

In one implementation, for a first iteration of the MMPS control process 400 are estimated based on the initialized state values determined at step S402. For subsequent iterations of the MMPS control process 400, the state vectors are updated based on a current state of the machines determined at step S408 during the previous iteration of the process 400. In some implementations, the processing circuitry of the controller 106 can detect occurrences of transient instability events based on the updated state vectors for each of the generators 202, 204, and 206. The state vectors may be updated based on sensed operational parameters at the generators 202, 204, and 206. In some implementations, the processing circuitry of the controller 106 may detect a transient instability event when the rotor angle, δᵢ, rotor speed, ωᵢ, and/or transient internal voltage, E_{qi}′, changes by more than a predetermined threshold between iterations of the MMPS control process 400.

At step S406, the processing circuitry of the controller determines a solution to an optimization problem to find the optimal control effort (u; =[uₖ_{ᵢ}, uₖ_{ᵢ}₊₁, . . . , uₖ_{ᵢ}_{+N}]) by solving cost function that achieves the control objective. In some implementations, the optimal control effort corresponds to an excitation voltage input that minimizes a predetermined cost function. At each sample, the excitation voltage constraints associated with equation (9) are taken into account when minimizing the cost function. In some aspects, the processing circuitry of the controller 106 determines upper and lower constraints for the excitation voltage input values based on a response of the machines to transient instability events. For example, the processing circuitry of the controller 106 can process the historical data stored in the database 108 to determine the upper and lower constraint values to restore the MMPS 114 to a state of equilibrium within a predetermined period of time after an occurrence of a transient instability event while maintaining the operational parameters of the generators 202, 204, and 206 within predetermined ranges. The processing circuitry of the controller 106 can determine that the state of equilibrium has been achieved when deviations of the sensor data associated with one or more the operational parameters of the generators 202, 204, and 206 are less than a predetermined threshold. In other implementations, the constraints can also include parameters other than the excitation voltage.

The cost function of the NMPC to control the stability MMPS 114 corresponds to a calculation of a sum of squared deviations between speeds of the machines and a reference speed of the MMPS 114, which can be described as follows:

$$J = {\sum }_{k = 0}^{N - 1} {( {ω}_{1} ( k ) - {ω}_{0} )}^{2} + {( {ω}_{2} ( k ) - {ω}_{0} )}^{2} + … {( {ω}_{i} ( k ) - {ω}_{0} )}^{2} \qquad ( 18 )$$

where ω(k) is a rotor speed of the ith machine, N is the prediction horizon, and ω₀ is a system reference speed. In some implementations, the processing circuitry of the controller 106 determines excitation voltage input values for each of the machines of the MMPS 114 in order to minimize the sum of the squared deviations between the speeds of the machines and a reference speed of the MMPS 114. Equation (18) is just one example of a cost function that can be used to provide NMPC to the MMPS 114, and other cost functions can also be used.

At step S408, a first entry of the excitation voltage control effort (u*=uₖ) is applied to the machines of the MMPS 114. For example, for machine 1 corresponds to generator 202, machine 2 corresponds to generator 204, and machine 3 corresponds to generator 206 for the MMPS 114. The controller 106 outputs control signals to one or more actuators associated with an excitation controller of the generators 202, 204, and 206 to apply the control effort values to achieve a predetermined system response, such as reducing a length of time of a transient instability event. For example, the control signals may be output to an excitation controller associated with each of the generators 202, 204, and 206. An updated state vector based on the response of the machines to the excitation voltage control effort is then determined, and then process 400 returns to step S404 to process the next sample.

According to certain embodiments, transient stability of the MMPS 114 can be tested under various conditions including a three-phase fault, load step change, and system parameter variations. For the transient stability tests described further herein, the excitation voltage constraints fall within the limits of −3≦uᵢ≦6.

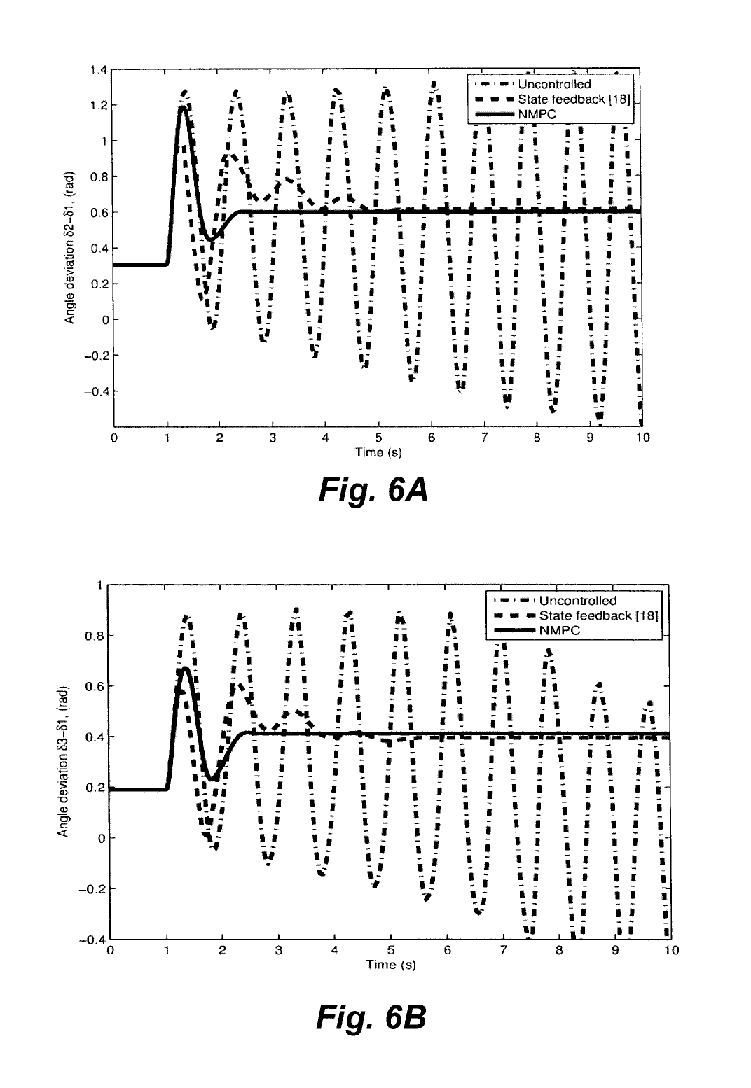

For the test of transient stability during a three-phase fault, a time of 1 second (s), a three-phase fault is applied near bus-220 at the end of line 216-220. The fault is cleared in five cycles (0.083 s) by fast relays opening the line 216-220. The MMPS 114 is restored to equilibrium, also referred to as steady-state before 1 s. FIGS. 6A and 6B are exemplary graphs of angle deviations between machines of the MMPS 114 during a three-phase fault.

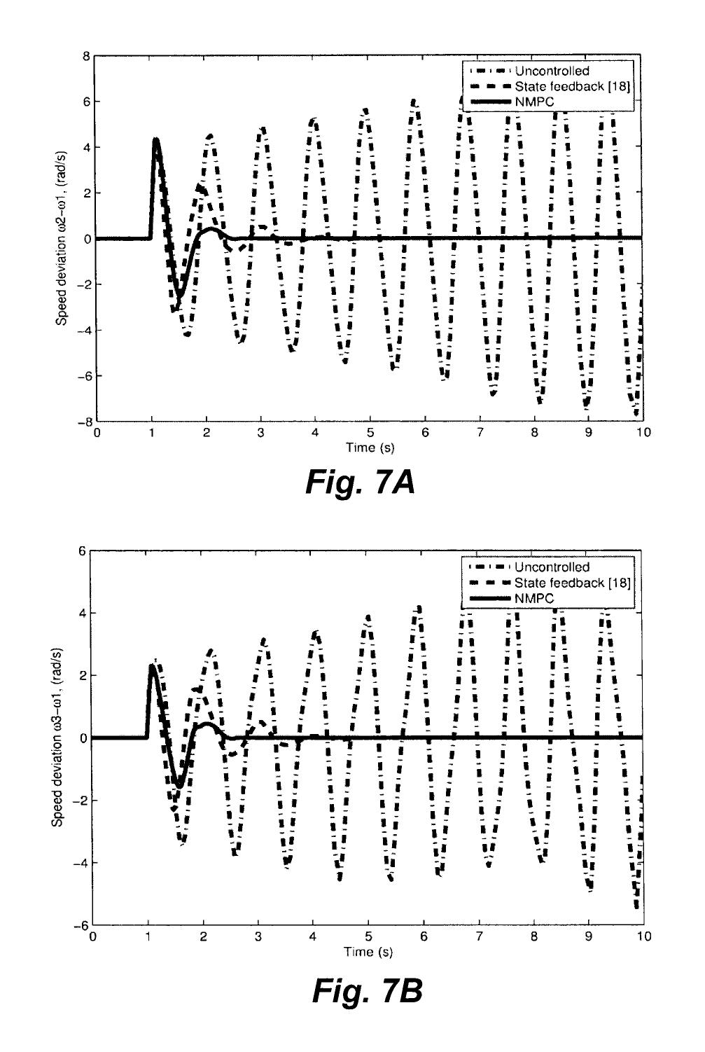

For example, FIG. 6A represents angle deviations between generators 202 and 204 (δ₂−δ₁) and FIG. 6B represents angle deviations (δ₃−δ₁) between generators 202 and 206. FIGS. 7A and 7B are graphs of speed deviations between the machines of the MMPS 114 during a three-phase fault, according to certain embodiments. FIG. 7A represents speed deviations between generators 202 and 204 (ω₂−ω₁) and FIG. 6B represents speed deviations (ω₃−ω₁) between generators 202 and 206. The graphs illustrate exemplary results for an uncontrolled case, a case where control of the MMPS 114 is implemented by a controller described in N. Yadaiah and N. V. Ramana, “Linearisation of multi-machine power system: Modeling and control—a survey,” International Journal of Electrical Power and Energy Systems, vol. 29, no. 4, pp. 297-311, 2007, and a case where the controller 106 implements the MMPS control process 400 with NMPC.

As can be seen from the FIGS. 6A-6B and 7A-7B, the MMPS control process 400 brings the angle deviations (δ₂−δ₁) and (δ₃−δ₁), and speed deviations (ω₂−ω₁) and (ω₃−ω₁) to steady state at time 2.62 s whereas with the feedback method described by N. Yadaiah and N. V. Ramana, “Linearisation of multi-machine power system: Modeling and control—a survey,” International Journal of Electrical Power and Energy Systems, vol. 29, no. 4, pp. 297-311, 2007, the angle and speed deviations reach the steady state at approximately 5 s, which is almost double the time to reach steady state with the MMPS control process 400. In addition, it can be seen that using the MMPS control process 400, oscillations of both angle deviations and speed deviations are also reduced. On the other hand, in the uncontrolled case, the MMPS 114 becomes unstable.

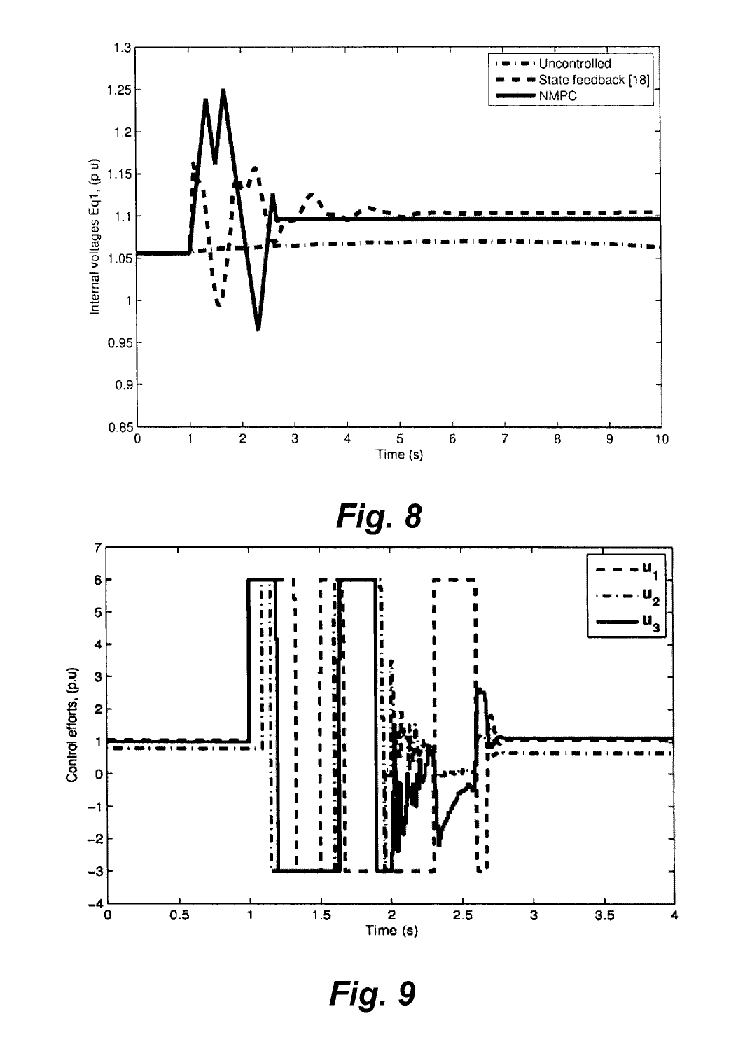

FIG. 8 is an exemplary graph of internal voltage of the generator 202 resulting after a three-phase fault, according to certain embodiments. The graph shows a comparison of generator 202 (machine 1) internal voltage E_{q1} using the MMPS control process 400 as well as when using the control method described by N. Yadaiah and N. V. Ramana, “Linearisation of multi-machine power system: Modeling and control—a survey,” International Journal of Electrical Power and Energy Systems, vol. 29, no. 4, pp. 297-311, 2007, and no control. The internal voltage reaches steady-state fastest with the MMPS control process 400, but more voltage overshoot is also observed.

FIG. 9 is an exemplary graph of control efforts (u₁, u₂, u₃) exerted by the controller 106 implementing the MMPS control process 400 based on NMPC in response to a three-phase fault, according to certain embodiments. The graph illustrates that when the three-phase fault occurs at time 1 s, the controller 106 applied large control efforts at the upper and lower constrain limits of 6 p.u. and −3 p.u. in order to bring the MMPS 114 to equilibrium as quickly as possible. In addition, it can be seen that the constraints imposed on the three inputs are satisfied over during the response of the controller 106 to the three-phase fault.

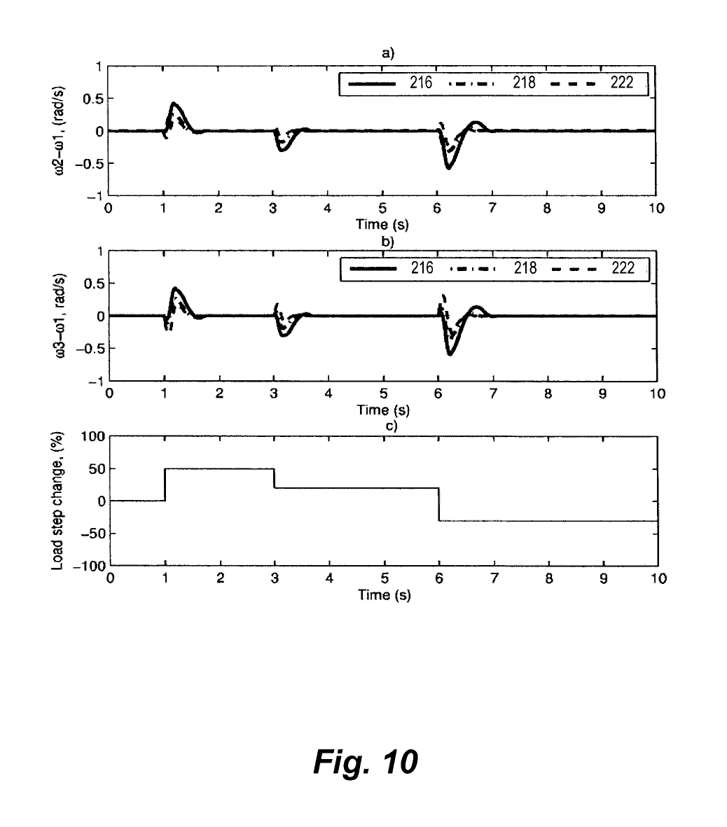

To test the response of the MMPS system 100 load step changes, different step load changes have been applied to three buses (216, 218, and 222) at different intervals. A (+50%) step change is applied at time of 1 s, then at time 3 s the load dropped by (−30%), and finally the load further dropped by (−50%) at time 6 s. FIG. 10 shows a comparison of the speed deviations between generators 202 and 204 (ω₂−ω₁) and generators 202 and 206 (ω₃−ω₁) for the three step load changes. From the graph, it can be seen that the proposed MMPS control process 400 can quickly damp the speed deviations (within 1 second). Also, the speed deviations are the highest when the load change is at bus 216.

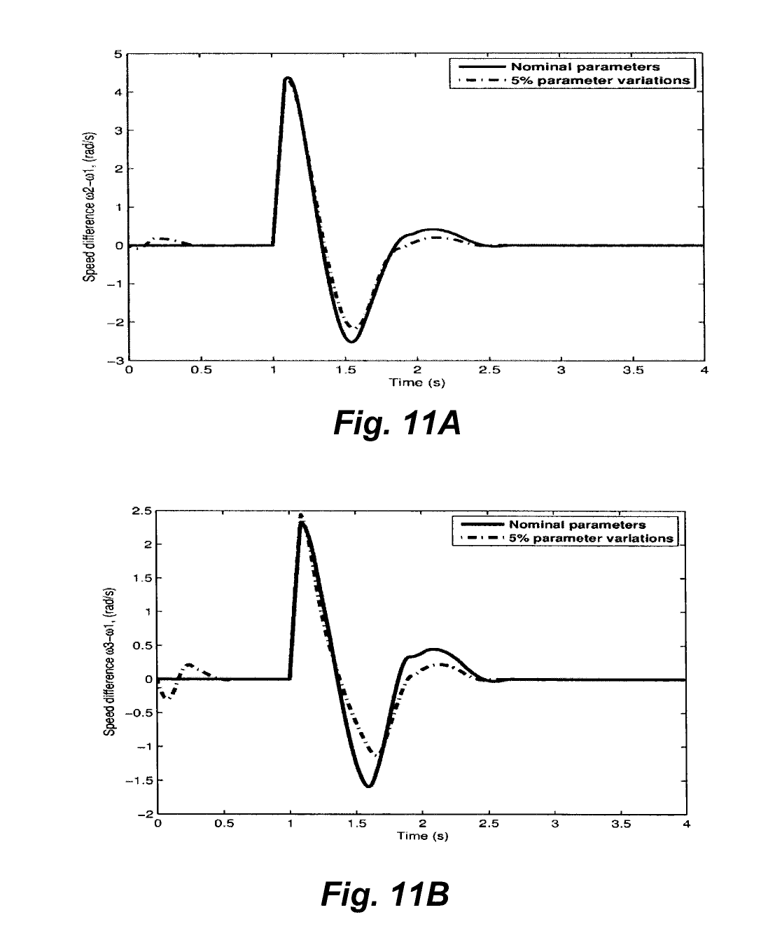

The MMPS system 100 can tested to show the robustness of the MMPS control process 400 in response to variations in the system parameters in the case of a three phase fault near bus 220. The variations of the system parameter are obtained by increasing the values of resistive and reactive components of the transmission line 218-224, and the transformers between buses 210-220 and 212-224 by 5%. From FIGS. 11A and 1B, it can seen that despite the changes in the system operating point due to variations of system parameters, the controller 106 is able to bring the MMPS 114 to the steady state in pre-fault and post-fault cases.

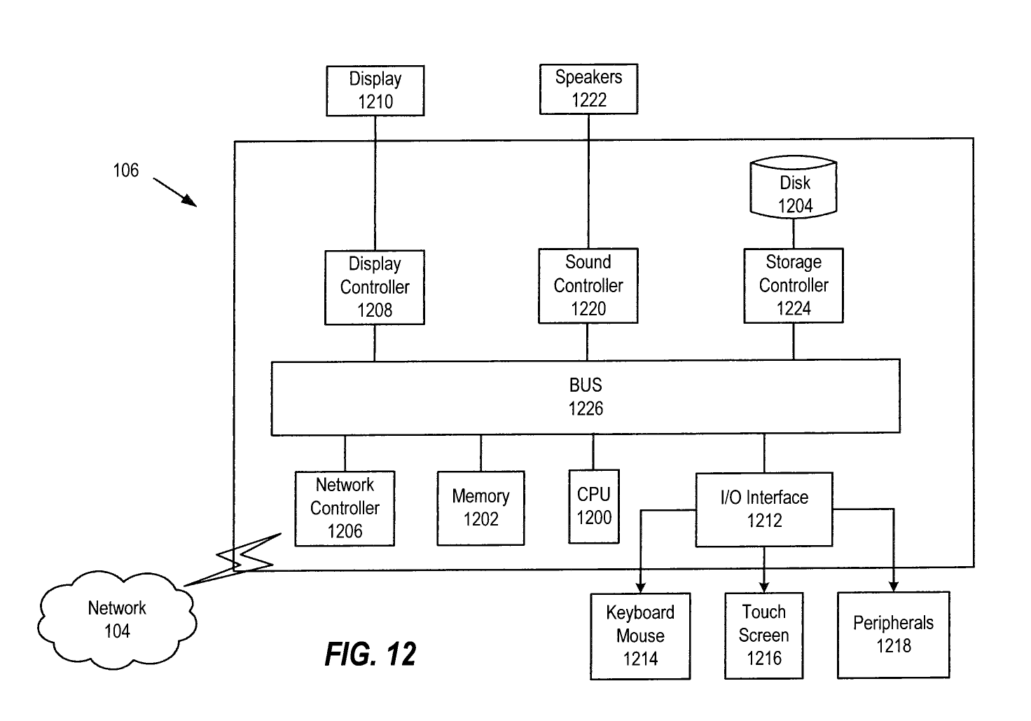

A hardware description of an exemplary controller 106 for performing one or more of the embodiments described herein is described with reference to FIG. 12. In addition, the hardware described by FIG. 12 can also apply to the computer 110 and/or mobile device 112. When the controller 106, computer 110, and/or mobile device 112 are programmed to perform the processes related to controlling the MMPS 114 with NMPC described herein, the controller 106, computer 110, and/or mobile device 112 becomes a special purpose device. Implementation of the processes of MMPS control system 100 on the hardware described herein improves the efficiency of maintaining stability of electrical systems having one or more electricity generation devices supplying one or more loads. In addition, the processes described herein can also be applied to other types of control system applications that utilize NMPC.

The controller 106 includes a CPU 1200 that perform the processes described herein. The process data and instructions may be stored in memory 1202. These processes and instructions may also be stored on a storage medium disk 1204 such as a hard drive (HDD) or portable storage medium or may be stored remotely. Note that each of the functions of the described embodiments may be implemented by one or more processing circuits. A processing circuit includes a programmed processor, as a processor includes circuitry. A processing circuit/circuitry may also include devices such as an application specific integrated circuit (ASIC) and conventional circuit components arranged to perform the recited functions. The processing circuitry can be referred to interchangeably as circuitry throughout the disclosure. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the controller 106 communicates, such as the MMPS 114 and/or the computer 110.

Further, the claimed advancements may be provided as a utility application, background daemon, or component of an operating system, or combination thereof, executing in conjunction with CPU 1200 and an operating system such as Microsoft Windows, UNIX, Solaris, LINUX, Apple MAC-OS and other systems known to those skilled in the art.

CPU 1200 may be a Xenon or Core processor from Intel of America or an Opteron processor from AMD of America, or may be other processor types that would be recognized by one of ordinary skill in the art. Alternatively, the CPU 1200 may be implemented on an FPGA, ASIC, PLD or using discrete logic circuits, as one of ordinary skill in the art would recognize. Further, CPU 1200 may be implemented as multiple processors cooperatively working in parallel to perform the instructions of the inventive processes described above.

The controller 106 in FIG. 12 also includes a network controller 1206, such as an Intel Ethernet PRO network interface card from Intel Corporation of America, for interfacing with network 104. As can be appreciated, the network 104 can be a public network, such as the Internet, or a private network such as an LAN or WAN network, or any combination thereof and can also include PSTN or ISDN sub-networks. The network 104 can also be wired, such as an Ethernet network, or can be wireless such as a cellular network including EDGE, 3G and 4G wireless cellular systems. The wireless network can also be Wi-Fi, Bluetooth, or any other wireless form of communication that is known.

The controller 106 further includes a display controller 1208, such as a NVIDIA GeForce GTX or Quadro graphics adaptor from NVIDIA Corporation of America for interfacing with display 1210 of the controller 106 and the computer 110, such as an LCD monitor. A general purpose I/O interface 1212 at the controller 106 interfaces with a keyboard and/or mouse 1214 as well as a touch screen panel 1216 on or separate from display 1210. General purpose I/O interface 1212 also connects to a variety of peripherals 1218 including printers and scanners.

A sound controller 1220 is also provided in the controller 106, such as Sound Blaster X-Fi Titanium from Creative, to interface with speakers/microphone 1222 thereby providing sounds and/or music.

The general purpose storage controller 1224 connects the storage medium disk 1204 with communication bus 1226, which may be an ISA, EISA, VESA, PCI, or similar, for interconnecting all of the components of the controller 106. A description of the general features and functionality of the display 1210, keyboard and/or mouse 1214, as well as the display controller 1208, storage controller 1224, network controller 1206, sound controller 1220, and general purpose I/O interface 1212 is omitted herein for brevity as these features are known.

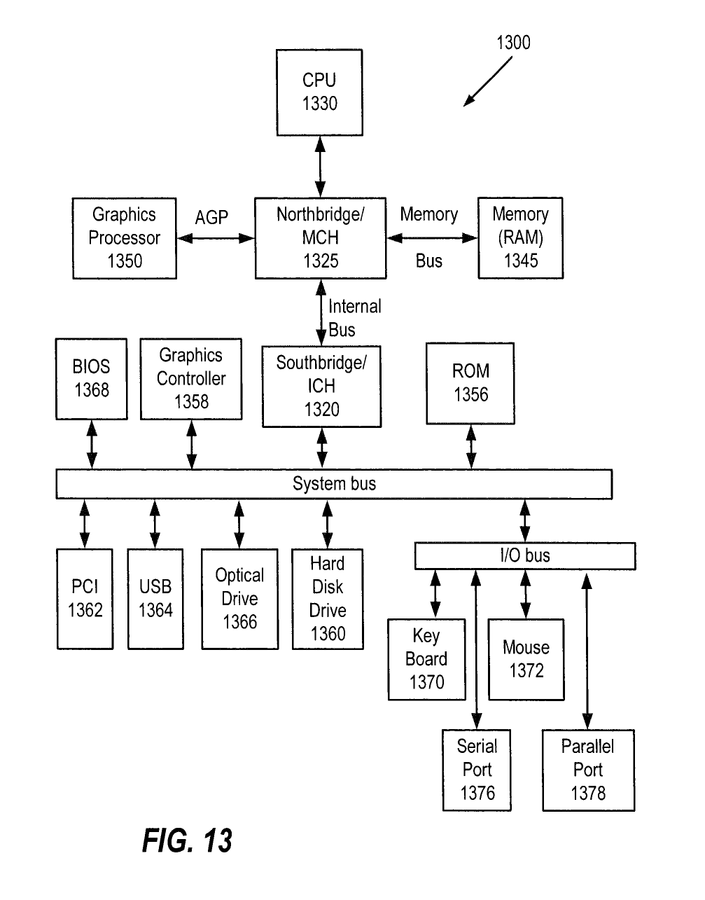

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset, as shown on FIG. 13.

FIG. 13 shows a schematic diagram of a data processing system, according to certain embodiments, for performing the MMPS control process 400 and/or NMPC process 300. The data processing system is an example of a computer in which code or instructions implementing the processes of the illustrative embodiments may be located.

In FIG. 13, data processing system 1300 employs a hub architecture including a north bridge and memory controller hub (NB/MCH) 1325 and a south bridge and input/output (I/O) controller hub (SB/ICH) 1320. The central processing unit (CPU) 1330 is connected to NB/MCH 1325. The NB/MCH 1325 also connects to the memory 1345 via a memory bus, and connects to the graphics processor 1350 via an accelerated graphics port (AGP). The NB/MCH 1325 also connects to the SB/ICH 1320 via an internal bus (e.g., a unified media interface or a direct media interface). The CPU Processing unit 1330 may contain one or more processors and even may be implemented using one or more heterogeneous processor systems.

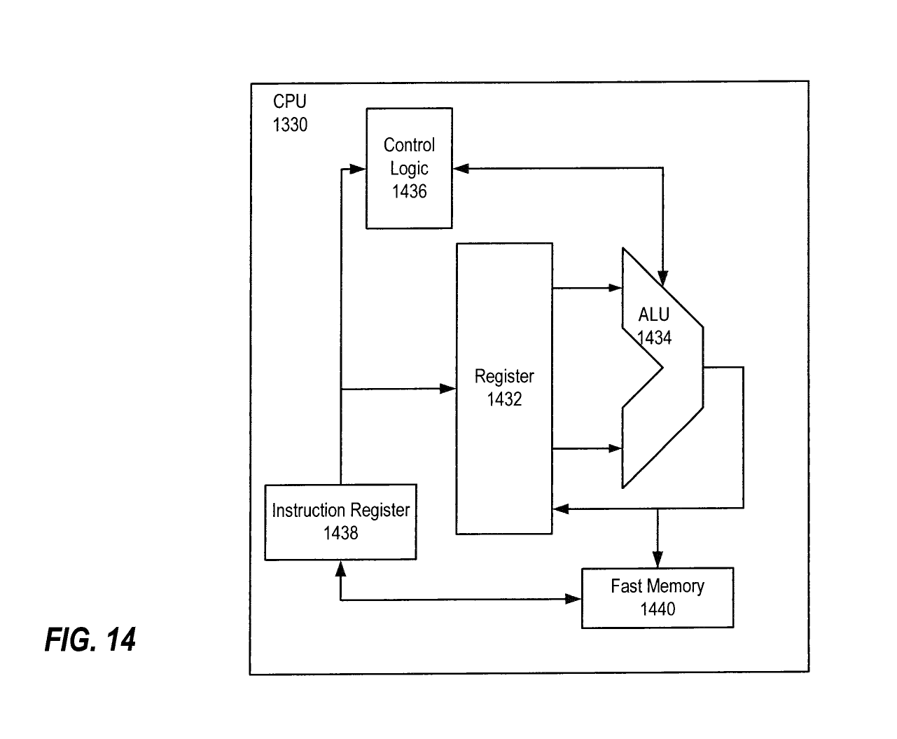

For example, FIG. 14 shows one implementation of CPU 1330. In one implementation, the instruction register 1438 retrieves instructions from the fast memory 1440. At least part of these instructions are fetched from the instruction register 1438 by the control logic 1436 and interpreted according to the instruction set architecture of the CPU 1330. Part of the instructions can also be directed to the register 1432. In one implementation the instructions are decoded according to a hardwired method, and in another implementation the instructions are decoded according a microprogram that translates instructions into sets of CPU configuration signals that are applied sequentially over multiple clock pulses. After fetching and decoding the instructions, the instructions are executed using the arithmetic logic unit (ALU) 1434 that loads values from the register 1432 and performs logical and mathematical operations on the loaded values according to the instructions. The results from these operations can be feedback into the register and/or stored in the fast memory 1440. According to certain implementations, the instruction set architecture of the CPU 1330 can use a reduced instruction set architecture, a complex instruction set architecture, a vector processor architecture, a very large instruction word architecture. Furthermore, the CPU 1330 can be based on the Von Neuman model or the Harvard model. The CPU 81330 can be a digital signal processor, an FPGA, an ASIC, a PLA, a PLD, or a CPLD. Further, the CPU 1330 can be an x86 processor by Intel or by AMD; an ARM processor, a Power architecture processor by, e.g., IBM; a SPARC architecture processor by Sun Microsystems or by Oracle; or other known CPU architecture.

Referring again to FIG. 13, the data processing system 1300 can include that the SB/ICH 1320 is coupled through a system bus to an I/O Bus, a read only memory (ROM) 1356, universal serial bus (USB) port 1364, a flash binary input/output system (BIOS) 1368, and a graphics controller 1358. PCI/PCIe devices can also be coupled to SB/ICH YYY through a PCI bus 1468.

The PCI devices may include, for example, Ethernet adapters, add-in cards, and PC cards for notebook computers. The Hard disk drive 1360 and CD-ROM 1366 can use, for example, an integrated drive electronics (IDE) or serial advanced technology attachment (SATA) interface. In one implementation the I/O bus can include a super I/O (SIO) device.

Further, the hard disk drive (HDD) 1360 and optical drive 1366 can also be coupled to the SB/ICH 1320 through a system bus. In one implementation, a keyboard 1370, a mouse 1372, a parallel port 1378, and a serial port 1376 can be connected to the system bust through the I/O bus. Other peripherals and devices that can be connected to the SB/ICH 1320 using a mass storage controller such as SATA or PATA, an Ethernet port, an ISA bus, a LPC bridge, SMBus, a DMA controller, and an Audio Codec.

Moreover, the present disclosure is not limited to the specific circuit elements described herein, nor is the present disclosure limited to the specific sizing and classification of these elements. For example, the skilled artisan will appreciate that the circuitry described herein may be adapted based on changes on battery sizing and chemistry, or based on the requirements of the intended back-up load to be powered.

The functions and features described herein may also be executed by various distributed components of a system. For example, one or more processors may execute these system functions, wherein the processors are distributed across multiple components communicating in a network. The distributed components may include one or more client and server machines, which may share processing in addition to various human interface and communication devices (e.g., display monitors, smart phones, tablets, personal digital assistants (PDAs)). The network may be a private network, such as a LAN or WAN, or may be a public network, such as the Internet. Input to the system may be received via direct user input and received remotely either in real-time or as a batch process. Additionally, some implementations may be performed on modules or hardware not identical to those described. Accordingly, other implementations are within the scope that may be claimed.

The above-described hardware description is a non-limiting example of corresponding structure for performing the functionality described herein. In other alternate embodiments, processing features according to the present disclosure may be implemented and commercialized as hardware, a software solution, or a combination thereof. Moreover, instructions corresponding to the MMPC control process 400 and/or NMPC process 300 in accordance with the present disclosure could be stored in a thumb drive that hosts a secure process.

According to certain embodiments, the MMPS control system 100 provides the processing power to control a response of the MMPS 114 to transient instability events that can reduce an operational efficiency of the MMPS 114. The processes described herein can also be applied to other technical fields that involve applying non-linear model predictive control to transient events associated with various control systems.

A number of implementations have been described. Nevertheless, it will be understood that various modifications may be made without departing from the spirit and scope of this disclosure. For example, preferable results may be achieved if the steps of the disclosed techniques were performed in a different sequence, if components in the disclosed systems were combined in a different manner, or if the components were replaced or supplemented by other components. The functions, processes and algorithms described herein may be performed in hardware or software executed by hardware, including computer processors and/or programmable circuits configured to execute program code and/or computer instructions to execute the functions, processes and algorithms described herein. Additionally, an implementation may be performed on modules or hardware not identical to those described. Accordingly, other implementations are within the scope that may be claimed.

1. A device comprising:
a controller including circuitry configured to
detect an occurrence of a transient instability event at a multi-machine power system (MMPS) based on one or more sensed operational parameters at one or more energy generation devices,
determine excitation voltage input values to the one or more energy generation devices over a predetermined prediction horizon based on minimizing a predetermined cost function bound by one or more constraints, and
output control signals to one or more actuators associated with the energy generation devices based on the excitation voltage input values to reduce a length of time of the transient instability event.

2. The device of claim 1, wherein the transient-instability event is a power disturbance, three-phase fault, or load change at one or more electrical busses of the MMPS.

3. The device of claim 1, wherein the one or more energy generation devices are represented by a third order model having a rotor angle component, a rotor speed component, and an internal transient voltage component.

4. The device of claim 1, wherein the circuitry is further configured to determine the excitation voltage input values to the one or more energy generation devices based on a nonlinear model predictive control (NMPC) model.

5. The device of claim 4, wherein the circuitry is further configured to control the length of time of the transient instability event without using flexible AC transmission system (FACTS) devices.

6. The device of claim 1, wherein the one or more energy generation devices of the MMPS include synchronous generators and induction generators.

7. The device of claim 1, wherein the one or more energy generation devices of the MMPS are driven by one or more power sources including wind, water, steam, or gas.

8. The device of claim 1, wherein the MMPS is a Western System Coordinating Council (WSCC) 3-machine, 9-bus power system.

9. The device of claim 1, wherein the circuitry is further configured to output the control signals to the one or more actuators associated with an excitation controller of the one or more energy generation devices.

10. The device of claim 1, wherein the one or more sensed operational parameters at the one or more energy generation devices include internal voltage, bus voltage, excitation voltage, current, rotor angle, and rotor speed.

11. The device of claim 1, wherein the circuitry is further configured to determine upper and lower constraints for the excitation voltage input values based on a response of one or more energy generation devices to the transient instability event.

12. The device of claim 1, wherein the circuitry is further configured to determine initial states for the one or more energy generation devices based on load flow data for the MMPS.

13. The device of claim 1, wherein the circuitry is further configured to determine the predetermined prediction horizon based on a system stability measurement of the MMPS and a processing capacity of the controller.

14. The device of claim 1, wherein the predetermined cost function corresponds to a calculation of a sum of squared deviations between speeds of the one or more energy generation devices and a reference speed of the MMPS.

15. The device of claim 14, wherein the circuitry is further configured to determine the excitation voltage input values for each of the one or more energy generation devices to minimize the sum of the squared deviations between the speeds of the one or more energy generation devices and the reference speed of the MMPS.

16. The device of claim 1, wherein the circuitry is further configured to restore the MMPS to equilibrium within a predetermined period of time after the occurrence of the transient instability event.

17. A method comprising:
detecting, via a controller having circuitry, an occurrence of a transient instability event at a multi-machine power system (MMPS) based on one or more sensed operational parameters at one or more energy generation devices;
determining, via the circuitry, excitation voltage input values to the one or more energy generation devices over a predetermined prediction horizon based on minimizing a predetermined cost function bound by one or more constraints; and
outputting, via the circuitry, control signals to one or more actuators associated with the energy generation devices based on the excitation voltage input values to reduce a length of time of the transient instability event.

18. The method of claim 17, wherein the one or more sensed operational parameters at the one or more energy generation devices include internal voltage, bus voltage, excitation voltage, current, rotor angle, and rotor speed.

19. The method of claim 17, wherein the method further comprises determining upper and lower constraints for the excitation voltage input values based on a response of one or more energy generation devices to the transient instability event.

20. A non-transitory computer readable medium having instructions stored therein that, when executed by one or more processor, cause the one or more processors to perform a method of controlling a response to transient instability events, the method comprising:
detecting an occurrence of a transient instability event at a multi-machine power system (MMPS) based on one or more sensed operational parameters at one or more energy generation devices;
determining excitation voltage input values to the one or more energy generation devices over a predetermined prediction horizon based on minimizing a predetermined cost function bound by one or more constraints; and
outputting control signals to one or more actuators associated with the energy generation devices based on the excitation voltage input values to reduce a length of time of the transient instability event.
